(19) United States
(12) Patent Application Publication
(10) Pub. No.: US 2025/0280337 A1
(43) Pub. Date: Sep. 4, 2025

(54) METHOD AND APPARATUS FOR COMMUNICATION IN AN IAB NETWORK

(71) Applicant: LENOVO (BEIJING) LIMITED, Beijing (CN)

(72) Inventors: Yibin Zhuo, Shanghai (CN); Mingzeng Dai, Shanghai (CN); Lianhai Wu, Beijing (CN); Le Yan, Shanghai (CN)

(21) Appl. No.: 18/858,494

(22) PCT Filed: Apr. 22, 2022
(86) PCT No.: PCT/CN2022/088388

§ 371 Date: Oct. 21, 2024

(51) Int. Cl. H04W 36/00; H04W 36/08

(52) U.S. Cl. CPC H04W 36/0064; H04W 36/08

(57) ABSTRACT

Embodiments of the present disclosure relate to communication in an integrated access and backhaul (IAB) network. According to some embodiments of the disclosure, a first BS may: receive, from a wireless network node or a second BS, a first indication indicating F1 interface setup completion between the wireless network node and the second BS, wherein the wireless network node is allowed to serve as a relay node between at least one of the first BS and the second BS and a UE, and the wireless network node migrates from the first BS to the second BS; and transmit, to the second BS, a first handover request message to hand over at least one UE served by the wireless network node from the first BS to the second BS in response to receiving the first indication.

### TECHNICAL FIELD

Embodiments of the present disclosure generally relate to communication technology, and more particularly to communication in an integrated access and backhaul (IAB) network.

### BACKGROUND

Wireless communication systems are widely deployed to provide various telecommunication services, such as telephony, video, data, messaging, broadcasts, and so on. Wireless communication systems may employ multiple access technologies capable of supporting communication with multiple users by sharing available system resources (e.g., time, frequency, and power). Examples of wireless communication systems may include fourth generation (4G) systems, such as long term evolution (LTE) systems, LTE-advanced (LTE-A) systems, or LTE-A Pro systems, and fifth generation (5G) systems which may also be referred to as new radio (NR) systems.

To extend the coverage and availability of wireless communication systems (e.g., 5G systems), the 3rd generation partnership project (3GPP) is envisioning integrated access and backhaul (IAB) architecture for supporting multi-hop relays. In an IAB network, an IAB node may hop through one or more IAB nodes before reaching a base station (also referred to as “an IAB donor” or “a donor node”). A single hop may be considered a special instance of multiple hops. Multi-hop backhauling is beneficial because it provides a relatively greater coverage extension compared to single-hop backhauling. In a relatively high frequency radio communication system (e.g., radio signals transmitted in frequency bands over 6 GHz), relatively narrow or less signal coverage may benefit from multi-hop backhauling techniques.

The industry desires technologies for handling wireless communications in the IAB network.

### SUMMARY

Some embodiments of the present disclosure provide a first base station (BS). The first BS may include a processor; and a transceiver coupled to the processor, wherein the transceiver is configured to: receive, from a wireless network node or a second BS, a first indication indicating F1 interface setup completion between the wireless network node and the second BS, wherein the wireless network node is allowed to serve as a relay node between at least one of the first BS and the second BS and a user equipment (UE), and the wireless network node migrates from the first BS to the second BS; and transmit, to the second BS, a first handover (HO) request message to hand over at least one UE served by the wireless network node from the first BS to the second BS in response to receiving the first indication.

Some embodiments of the present disclosure provide a wireless network node. The wireless network node may include: a transceiver configured to receive a downlink (DL) data packet from a parent node of the wireless network node; and a processor coupled to the transceiver, wherein the processor is configured to determine whether to deliver the DL data packet to a first distributed unit (DU) of the wireless network node or a second DU of the wireless network node, wherein the first DU is associated with a first base station (BS), the second DU is associated with a second BS, and the wireless network node migrates from the first BS to the second BS.

Some embodiments of the present disclosure provide a method performed by a first base station (BS). The method may include: receiving, from a wireless network node or a second BS, a first indication indicating F1 interface setup completion between the wireless network node and the second BS, wherein the wireless network node is allowed to serve as a relay node between at least one of the first BS and the second BS and a user equipment (UE), and the wireless network node migrates from the first BS to the second BS; and transmitting, to the second BS, a first handover (HO) request message to hand over at least one UE served by the wireless network node from the first BS to the second BS in response to receiving the first indication.

Some embodiments of the present disclosure provide a method performed by a wireless network node. The method may include: receiving a downlink (DL) data packet from a parent node of the wireless network node; and determining whether to deliver the DL data packet to a first distributed unit (DU) of the wireless network node or a second DU of the wireless network node, wherein the first DU is associated with a first base station (BS), the second DU is associated with a second BS, and the wireless network node migrates from the first BS to the second BS.

Some embodiments of the present disclosure provide an apparatus. According to some embodiments of the present disclosure, the apparatus may include: at least one non-transitory computer-readable medium having stored thereon computer-executable instructions; at least one receiving circuitry; at least one transmitting circuitry; and at least one processor coupled to the at least one non-transitory computer-readable medium, the at least one receiving circuitry and the at least one transmitting circuitry, wherein the at least one non-transitory computer-readable medium and the computer executable instructions may be configured to, with the at least one processor, cause the apparatus to perform a method according to some embodiments of the present disclosure.

Embodiments of the present disclosure provide technical solutions to facilitate and improve the implementation of various communication technologies, such as 5G NR.

### BRIEF DESCRIPTION OF THE DRAWINGS

In order to describe the manner in which the advantages and features of the disclosure can be obtained, a description of the disclosure is rendered by reference to specific embodiments thereof, which are illustrated in the appended drawings. These drawings depict only exemplary embodiments of the disclosure and are not therefore to be considered limiting of its scope.

FIG. 1 illustrates a schematic diagram of a wireless communication system in accordance with some embodiments of the present disclosure;

FIG. 2 illustrates an example block diagram of a protocol stack for an IAB network in accordance with some embodiments of the present disclosure;

FIG. 3 illustrates an example block diagram of a protocol stack for an IAB network in accordance with some embodiments of the present disclosure;

FIGS. 4-7 illustrate a flow chart of an exemplary procedure of wireless communications in accordance with some embodiments of the present disclosure; and

FIG. 8 illustrates a block diagram of an exemplary apparatus in accordance with some embodiments of the present disclosure.

### DETAILED DESCRIPTION

The detailed description of the appended drawings is intended as a description of the preferred embodiments of the present disclosure and is not intended to represent the only form in which the present disclosure may be practiced. It should be understood that the same or equivalent functions may be accomplished by different embodiments that are intended to be encompassed within the spirit and scope of the present disclosure.

Reference will now be made in detail to some embodiments of the present disclosure, examples of which are illustrated in the accompanying drawings. To facilitate understanding, embodiments are provided under specific network architectures and new service scenarios, such as the 3rd generation partnership project (3GPP) 5G (NR), 3GPP long-term evolution (LTE) Release 8, and so on. It is contemplated that along with the developments of network architectures and new service scenarios, all embodiments in the present disclosure are also applicable to similar technical problems; and moreover, the terminologies recited in the present disclosure may change, which should not affect the principles of the present disclosure.

Compared with the 4G communication system, the 5G communication system has raised more stringent requirements for various network performance indicators, for example, a 1000-time capacity increase, wider coverage requirements, ultra-high reliability, ultra-low latency, etc. Considering the rich frequency resources of high-frequency carriers, the use of high-frequency small station deployments is becoming more and more popular in hotspot areas in order to meet the needs of 5G ultra-high capacity. However, high-frequency carriers have poor propagation characteristics, severe attenuation due to obstructions, and limited coverage. Therefore, the dense deployment of small stations is required. In addition, the deployment of optical fiber may be difficult and costly for these small stations. Therefore, an economical and convenient backhaul scheme is needed. Integrated access and backhaul (IAB) technology, whose access link(s) and backhaul link(s) may both use wireless transmission solutions to avoid fiber deployment, provides ideas for solving the above problems.

In an IAB network, a wireless network node such as a relay node (RN) or an IAB node or a wireless backhaul node/device can provide wireless access services for UEs. That is, a UE can connect to an IAB donor relayed by one or more IAB nodes. The IAB donor may also be called a donor node or a donor base station (e.g., DgNB, Donor gNodeB). In addition, the wireless link between an IAB donor and an IAB node, or the wireless link between different IAB nodes can be referred to as a “backhaul link.”

An IAB node may include an IAB mobile terminal (MT) part and an IAB distributed unit (DU) part. When an IAB node connects to its parent node (which may be another IAB node or an IAB donor), it can be regarded as a UE, i.e., the role of an MT. When an IAB node provides service to its child node (which may be another IAB node or a UE), it can be regarded as a network device, i.e., the role of a DU.

An IAB donor can be an access network element with a complete base station function, or an access network element with a separate form of a centralized unit (CU) and a distributed unit (DU). The IAB donor may be connected to the core network (for example, connected to the 5G core network (5GC)), and provide the wireless backhaul function for the IAB nodes. The CU of an IAB donor may be in referred to as an “IAB donor-CU” (or directly referred to as a “CU”), and the DU of the IAB donor may be referred to as an “IAB donor-DU.” The IAB donor-CU may be separated into a control plane (CP) and a user plane (UP). For example, a CU may include one CU-CP and one or more CU-UPs.

Considering the limited coverage of a high frequency band, and in order to ensure coverage performance of the network, multi-hop networking may be adopted in an IAB network. Taking into account the requirements of service transmission reliability, IAB nodes can support dual connectivity (DC) or multi-connectivity to improve the transmission reliability, so as to deal with abnormal situations that may occur on the backhaul (BH) link, such as radio link failure (RLF) or blockage, load fluctuations, etc.

In the case where an IAB network supports multi-hop and dual-connection networking, there may be multiple transmission paths between the UE and the IAB donor. A transmission path may include multiple nodes, such as a UE, one or more IAB nodes, and an IAB donor (if the IAB donor is in the form of a separate CU and DU, it may also contain an IAB donor-DU and an IAB donor-CU). Each IAB node may treat the neighboring node that provides backhaul services for it as a parent node (or parent IAB node), and each IAB node can be regarded as a child node (or child IAB node) of its parent node.

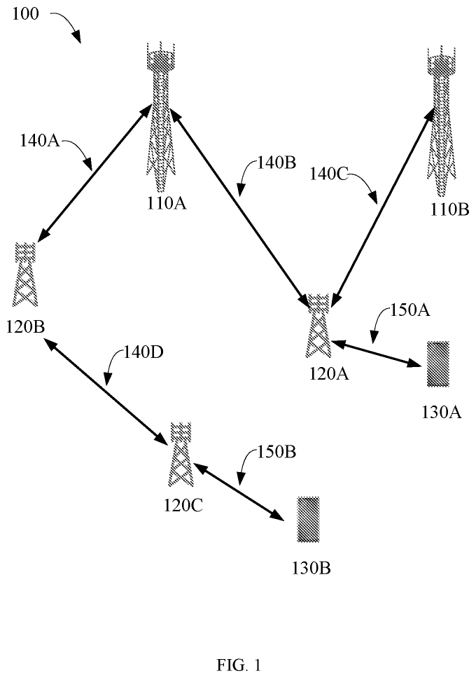

FIG. 1 illustrates a schematic diagram of wireless communication system 100 in accordance with some embodiments of the present disclosure.

As shown in FIG. 1, the wireless communication system 100 may include some base stations (e.g., IAB donor 110A and IAB donor 110B), some IAB nodes (e.g., IAB node 120A, IAB node 120B, and IAB node 120C), and some UEs (e.g., UE 130A and UE 130B). Although a specific number of UEs, IAB nodes, and IAB donors are depicted in FIG. 1, it is contemplated that any number of UEs, IAB nodes, and IAB donors may be included in the wireless communication system 100.

Each of IAB donor 110A, IAB donor 110B, IAB node 120A, IAB node 120B, and IAB node 120C may be directly connected to one or more IAB node(s) in accordance with some other embodiments of the present disclosure. Each of IAB donor 110A, IAB donor 110B, IAB node 120A, IAB node 120B, and IAB node 120C may be directly connected to one or more UEs in accordance with some other embodiments of the present disclosure.

UE 130A and UE 130B may be any type of device configured to operate and/or communicate in a wireless environment. For example, UE 130A and UE 130B may include a computing device, such as a desktop computer, a laptop computer, a personal digital assistant (PDA), a tablet computer, a smart television (e.g., television connected to the Internet), a set-top box, a game console, a security system (including a security camera), a vehicle on-board computer, a network device (e.g., router, switch, and modem), or the like. According to some embodiments of the present disclosure, UE 130A and UE 130B may include a portable wireless communication device, a smart phone, a cellular telephone, a flip phone, a device having a subscriber identity module, a personal computer, a selective call receiver, or any other device that is capable of transmission and receiving communication signals on a wireless network. In some embodiments of the present disclosure, UE 130A and UE 130B may include wearable devices, such as smart watches, fitness bands, optical head-mounted displays, internet-of-things (IoT) devices, or the like. Moreover, UE 130A and UE 130B may be referred to as a subscriber unit, a mobile, a mobile station, a user, a terminal, a mobile terminal, a wireless terminal, a fixed terminal, a subscriber station, a user terminal, or a device, or described using other terminology used in the art.

IAB donors 110A and 110B may be in communication with a core network (not shown in FIG. 1). The core network (CN) may include a plurality of core network components, such as a mobility management entity (MME) (not shown in FIG. 1) or an access and mobility management function (AMF) (not shown in FIG. 1). The CNs may serve as gateways for the UEs to access a public switched telephone network (PSTN) and/or other networks (not shown in FIG. 1).

Wireless communication system 100 may be compatible with any type of network that is capable of transmitting and receiving wireless communication signals. For example, the wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high altitude platform network, and/or other communications networks.

In some embodiments of the present disclosure, the wireless communication system 100 is compatible with 5G NR of the 3GPP protocol. For example, IAB donors 110A and 110B may transmit data using an orthogonal frequency division multiple (OFDM) modulation scheme on the DL. UE 130A and UE 130B may transmit data on the UL using a discrete Fourier transform-spread-orthogonal frequency division multiplexing (DFT-S-OFDM) or cyclic prefix-OFDM (CP-OFDM) scheme. More generally, however, the wireless communication system 100 may implement some other open or proprietary communication protocols, for example, WiMAX, among other protocols.

Persons skilled in the art should understand that as technology develops and advances, the terminologies described in the present disclosure may change, but should not affect or limit the principles and spirit of the present disclosure.

Referring to FIG. 1, IAB node 120A can be directly connected to IAB donors 110A and 110B, and IAB node 120B can be directly connected to IAB donor 110A. IAB donors 110A and 110B are parent nodes of IAB node 120A, and IAB donor 110A is a parent node of IAB node 120B. In other words, IAB nodes 120A and 120B are child IAB nodes of IAB donor 110A, and IAB node 120A is also a child IAB node of IAB donor 110B. IAB node 120C can reach IAB donor 110A by hopping through IAB node 120B. IAB node 120B is a parent IAB node of IAB node 120C. In other words, IAB node 120C is a child IAB node of IAB node 120B.

In some other embodiments of the present disclosure, an IAB node may be connected to IAB node 120C so it can reach IAB donor 110A by hopping through IAB node 120C and IAB node 120B. This IAB node and IAB node 120C may be referred to as the descendant IAB nodes of IAB node 120B.

UEs 130A and 130B can be connected to IAB nodes 120A and 120C, respectively. Uplink (UL) packets (e.g., data or signaling) from UE 130A or UE 130B can be transmitted to an IAB donor (e.g., IAB donor 110A or 110B) via one or more IAB nodes, and then transmitted by the IAB donor to a mobile gateway device (such as the user plane function (UPF) in the 5GC). Downlink (DL) packets (e.g., data or signaling) can be transmitted from the IAB donor (e.g., IAB donor 110A or 110B) after being received by the gateway device, and then transmitted to UE 130A or 130B through one or more IAB nodes.

For example, referring to FIG. 1, UE 130A may transmit UL data to IAB donor 110A or 110B or receive DL data therefrom via IAB node 120A. UE 130B may transmit UL data to IAB donor 110A or receive DL data therefrom via IAB node 120C and IAB node 120B.

In an IAB deployment such as the wireless communication system 100, the radio link between an IAB donor (e.g., IAB donor 110A or 110B in FIG. 1) and an IAB node or between two IAB nodes may be referred to as a backhaul link (BL). The radio link between an IAB donor (e.g., IAB donor 110A or 110B in FIG. 1) and a UE or between an IAB node and a UE may be referred to as an access link (AL). For example, in FIG. 1, radio links 140A to 140D are BLs and radio links 150A and 150B are ALs.

A protocol layer, the backhaul adaptation protocol (BAP) layer, located above the radio link control (RLC) layer, is introduced in an IAB system and can be used to realize packet routing, bearer mapping and flow control on the wireless backhaul link.

An F1 interface may be established between an IAB node (e.g., the DU part of the IAB node) and an IAB donor (e.g., IAB donor-CU). The F1 interface may support both a user plane protocol (e.g., F1-U) and a control plane protocol (e.g., F1-C). The user plane protocol of the F1 interface may include one or more of a general packet radio service (GPRS) tunneling protocol user plane (GTP-U), user datagram protocol (UDP), internet protocol (IP) and other protocols. The control plane protocol of the F1 interface may include one or more of an F1 application protocol (F1AP), stream control transport protocol (SCTP), IP, and other protocols.

Through the control plane of the F1 interface, an IAB node and an IAB donor can perform, for example, interface management, IAB-DU management, and a UE context-related configuration. Through the user plane of the F1 interface, an IAB node and an IAB donor can perform, for example, user plane data transmission and downlink transmission status feedback functions.

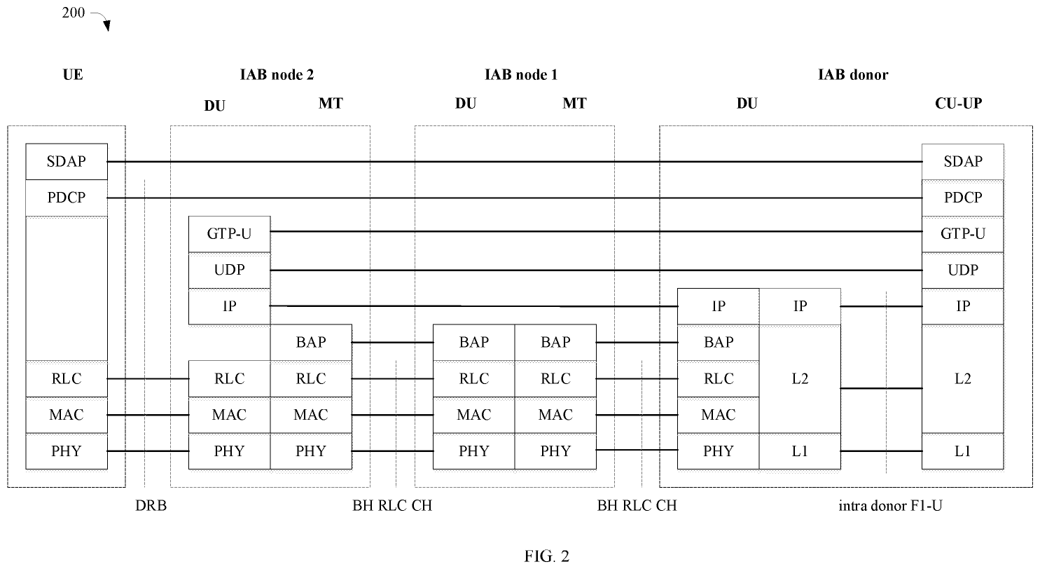

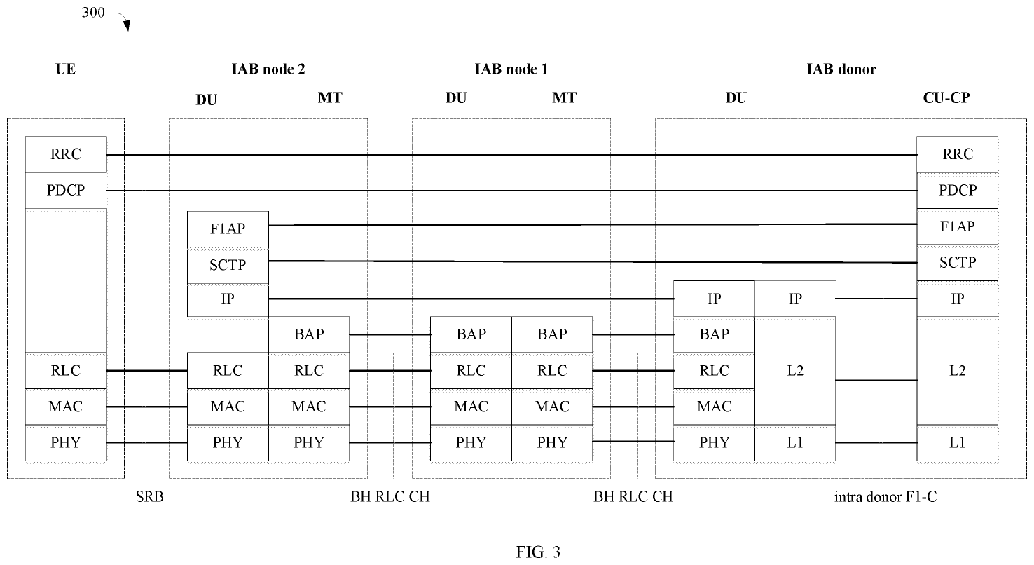

FIG. 2 illustrates an example block diagram of user plane (UP) protocol stack 200 for an IAB network according to some embodiments of the present disclosure. FIG. 3 illustrates an example block diagram of control plane (CP) protocol stack 300 for an IAB network according to some embodiments of the present disclosure. In FIGS. 2 and 3, a UE may be connected to an IAB donor via IAB node 2 and IAB node 1.

Referring to FIG. 2, the UP protocol stack of the UE may include a service data adaptation protocol (SDAP) layer, a packet data convergence protocol (PDCP) layer, a radio link control (RLC) layer, a medium access control (MAC) layer, and a physical (PHY) layer. The UP protocol stack of the DU of IAB node 2 may include a GTP-U layer, a UDP layer, an IP layer, an RLC layer, a MAC layer, and a PHY layer. The UP protocol stack of the MT of IAB node 2 or the DU or MT of IAB node 1 may include a BAP layer, an RLC layer, a MAC layer, and a PHY layer. The UP protocol stack of the DU of the IAB donor may include an IP layer, a BAP layer, an RLC layer, a MAC layer, and a PHY layer, where the PHY layer belongs to layer 1 (L1), and the BAP layer, the RLC layer, and the MAC layer belong to layer 2 (L2). The protocol stack of the CU-UP of the IAB donor may include a GTP-U layer, a UDP layer, an IP layer, an SDAP layer, a PDCP layer, an L2 layer(s), and an L1 layer.

Referring to FIG. 3, the CP protocol stack of the UE may include a radio resource control (RRC) layer, a PDCP layer, an RLC layer, a MAC layer, and a physical (PHY) layer. The CP protocol stack of the DU of IAB node 2 may include an F1AP layer, an SCTP layer, an IP layer, an RLC layer, a MAC layer, and a PHY layer. The CP protocol stack of the MT of IAB node 2 or the DU or MT of IAB node 1 may include a BAP layer, an RLC layer, a MAC layer, and a PHY layer. The CP protocol stack of the DU of the IAB donor may include an IP layer, a BAP layer, an RLC layer, a MAC layer, and a PHY layer, where the PHY layer belongs to L1, and the BAP layer, the RLC layer, and the MAC layer belong to L2. The protocol stack of the CU-CP of the IAB donor may include an RRC layer, a PDCP layer, an F1AP layer, an SCTP layer, an IP layer, an L2 layer(s), and an L1 layer.

The protocol stacks shown in FIGS. 2 and 3 are only for illustrative purposes. For example, the sequences of some of the protocol layers in the protocol stacks of FIGS. 2 and 3 may be rearranged for illustrative purposes. For example, although the SDAP and PDCP layers belong to L2, they are shown above the GTP-U layer, the UDP layer and the IP layer in the protocol stack of the CU-UP of the IAB donor in FIG. 2.

As demand for improved cellular coverage and connectivity continues to increase, communications in outdoor and mobility scenarios may face more challenges. In some embodiments of the present disclosure, a mobile wireless network node which acts as a relay between a UE and the 3GPP communication network (e.g., 5G) may be employed to facilitate communications in such scenarios. The mobile wireless network node may provide, for example, an access link to UEs and connected wirelessly (e.g., using NR) through a BS (e.g., donor next-generation radio access network (NG-RAN)) to the core network. In some examples, such mobile wireless network node may also be referred to as a mobile base station relay or mobile relay. The above descriptions with respect to the wireless network node and the IAB node can be applied to the mobile base station relay. That is, a mobile base station relay can be a mobile IAB node.

In some examples, the mobile base station relay may be mounted on a vehicle. The mobile base station relay may serve UEs that are located inside or outside the vehicle, or UEs that enter or leave the vehicle. In the context of the present disclosure, inside or outside of a mobile base station relay may mean inside or outside of a vehicle or other device(s) on which the mobile wireless network node is mounted.

In some examples, the radio link used between a mobile base station relay and the served UEs, as well as between the mobile base station relay and the BS, may be a Uu link (e.g., NR-Uu). In some examples, there may be at least one hop between a UE and a mobile base station relay. In some examples, there may be at least one hop between a mobile base station relay and a BS.

The employment of such mobile wireless network node is advantageous in various aspects and can be applied to various scenarios. For example, in some outdoor environments, the availability of vehicles equipped with mobile base station relays, either following a certain known/predictable itinerary (e.g., buses, trams, etc.), or situated in convenient locations (e.g., outside stadiums, hot-spot areas, or emergency sites), may provide a very opportunistic boost to cellular coverage and capacity when or where needed. Those relays may use, for example, a 5G wireless backhaul toward the macro network, and thus can offer better coverage and connectivity to neighboring UEs. Mobile relays are also very suitable for improving connectivity for users or devices inside a vehicle on which the mobile relay is mounted in different environments, for example, for passengers in buses, cars/taxis, or trains, ad-hoc/professional personnel or equipment. Such mobile wireless network node can also be used for reaching users or devices that would otherwise have no or very poor macro coverage, for example, in the case of first responders dislocated in indoor buildings/areas, using relays placed on their nearby or outside vehicles to get required coverage and connectivity.

The technical benefits of using such mobile wireless network node further include, among others, the ability to get better macro coverage than a nearby UE, for example, exploiting better radio frequency, antenna and power capabilities. In addition, besides the value for network operators and end users, worthy incentives may be found for other parties as well, for example, for vehicle manufacturers, and vehicle and fleet owners or providers, to install and operate relays in their vehicles.

In some scenarios, a wireless network node (e.g., stationery or mobile) can be migrated (or handed over) from one BS (source BS or source IAB donor) to another BS (target BS or target IAB donor), or a wireless network node can be migrated to another parent node under another BS. For example, referring back to FIG. 1, IAB node 120C or IAB node 120B may be migrated from IAB donor 110A to IAB donor 110B.

In some embodiments, only the MT of a wireless network node (e.g., an IAB node) may be migrated to from a source BS (e.g., source IAB donor) to a target BS (e.g., target IAB donor). For example, the MT of an IAB node may be migrated to a different parent node underneath the CU of the target IAB donor. For example, referring to FIG. 1, the MT of IAB node 120C may migrate to IAB node 120A underneath IAB donor 110B. In this scenario, the collocated DU of the IAB node and the DUs of its descendant IAB nodes (if any) may retain the F1 connectivity with the source IAB donor (e.g., CU of the source IAB donor). This migration may be referred to as partial migration or inter-donor partial migration. The IAB node may be referred to as a boundary IAB node. After the partial migration, the F1 traffic of the DU of the IAB node and its descendent nodes is routed via the BAP layer of the topology to which the MT of the IAB node has migrated.

In some embodiments, both the MT and the DU of a wireless network node (e.g., an IAB node) may be migrated to from a source BS (e.g., source IAB donor) to a target BS (e.g., target IAB donor). For example, the MT of an IAB node may be migrated to a different parent node underneath the CU of the target IAB donor, and the collocated DU of this IAB node may also migrate its F1 connectivity to the target IAB donor (e.g., CU of the target IAB donor). This migration may be referred to as full migration or inter-donor full migration. In some examples, the descendent nodes of the IAB node (e.g., child IAB nodes and UEs served by the IAB node) also migrate to the target IAB donor (e.g., CU of the target IAB donor).

Embodiments of the present disclosure provide solutions to implement the full migration of a wireless network node (e.g., an IAB node). More details on the embodiments of the present disclosure will be illustrated in the following text in combination with the appended drawings.

In some embodiments of the present disclosure, for the full migration of a wireless network node (e.g., an IAB node), two DUs (e.g., IAB-DUs) may be introduced for the migration wireless network node. For example, each of the two IAB-DUs of the wireless network node may maintain respective F1 connectivity to the source BS and target BS, respectively. The following text describes exemplary full migration procedures, where the migration wireless network node has two IAB-DUs.

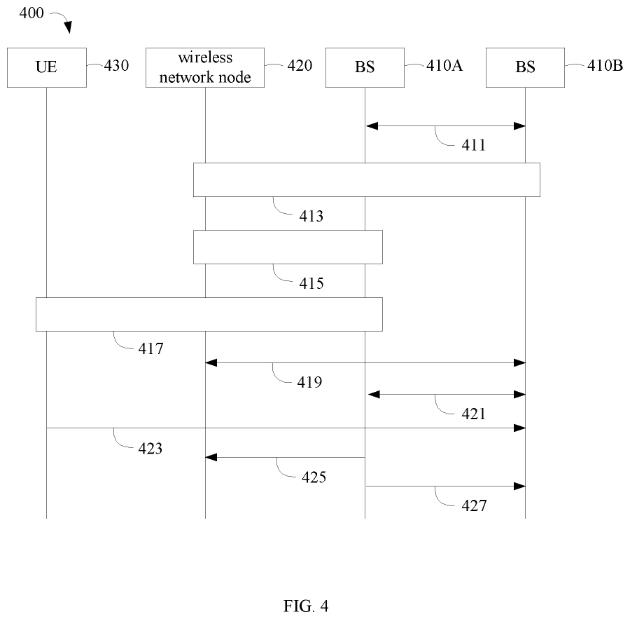

FIG. 4 illustrates a flow chart of exemplary procedure 400 for wireless communications in accordance with some embodiments of the present disclosure. Details described in all of the foregoing embodiments of the present disclosure are applicable for the embodiments shown in FIG. 4.

Referring to FIG. 4, wireless network node 420 may be directly or indirectly connected to BS 410A. For example, wireless network node 420 may be connected to a parent node (not shown in FIG. 4) which may be directly or indirectly connected to BS 410A. Wireless network node 420 may serve as a relay node between BS 410A and one or more UEs (e.g., UE 430).

In some embodiments, wireless network node 420 may include an MT and a DU (denoted as DU #1), BS 410A may include a CU and a DU, and BS 410B may include a CU and a DU. For example, wireless network node 420 may be an IAB node and BS 410A and BS 410B may be an IAB donor. Both the MT and DU #1 of wireless network node 420 may be anchored at BS 410A (e.g., CU of BS 410A).

In operation 411, BS 410A and BS 410B may perform a handover (HO) preparation procedure for the MT of wireless network node 420. For example, BS 410A (e.g., CU of BS 410A) may transmit a handover request message to BS 410B (e.g., CU of BS 410B). BS 410B (e.g., CU of BS 410B) may perform admission control and transmit a handover request acknowledgement message to BS 410A (e.g., CU of BS 410A). The handover request acknowledgement message may include a new RRC configuration for the MT of wireless network node 420. BS 410A (e.g., CU of BS 410A) may transmit the new RRC configuration (e.g., in an RRC reconfiguration message) to wireless network node 420 (not shown in FIG. 4).

In operation 413, the MT of wireless network node 420 may be handed over from BS 410A (source BS) to BS 410B (target BS). For example, in response to receiving the RRC reconfiguration message, the MT of wireless network node 420 may perform a random access procedure with BS 410B (e.g., DU of BS 410B) and hand over (or migrate) to BS 410B (e.g., CU of BS 410B).

In operation 415, in response to the completion of the HO of the MT of wireless network node 420, the F1 interface (e.g., F1-C and F1-U connectivity) between wireless network node 420 (e.g., DU #1) and BS 410A (e.g., CU of BS 410A) may be switched from the source path to the target path. The source path refers to the path between wireless network node 420 and BS 410A (e.g., DU of BS 410A). The target path refers to the path between wireless network node 420 and BS 410B (e.g., DU of BS 410B). For example, the F1 interface for DU #1 may be transported via the DU of BS 410B to CU of BS 410A.

In operation 417, in response to the completion of the HO of the MT of wireless network node 420, the RRC connection of UE 430 may be switched from the source path to the target path. For example, the RRC connection for UE 430 may be transported via the DU of BS 410B to CU of BS 410A.

The above operations may be referred to as a partial migration procedure.

In operation 419, an F1 interface between wireless network node 420 and BS 410B may be set up via the target path. For example, for full migration of wireless network node 420, another DU (denoted as DU #2) may be introduced for establishing the F1 interface with BS 410B (e.g., CU of BS 410B). That is, DU #1 of wireless network node 420 is associated with the source BS (BS 410A) and DU #2 of wireless network node 420 is associated with the target BS (BS 410B). In response to the completion of the F1 interface setup between DU #2 and the CU of BS 410B, the cells of DU #2 may be activated and ready to serve UEs.

In some embodiments, in response to the F1 interface setup completion between wireless network node 420 and BS 410B, wireless network node 420 or BS 410B (e.g., CU of BS 410B) may transmit an indication to BS 410A (e.g., CU of BS 410A) to inform of this F1 interface setup completion.

In response to the indication, BS 410A (e.g., CU of BS 410A) may trigger an HO procedure for the serving UEs (e.g., UE 430) of wireless network node 420 in operation 421. For example, BS 410A (e.g., CU of BS 410A) may transmit, to BS 410B (e.g., CU of BS 410B), a handover request message to hand over at least one UE (e.g., UE 430) served by wireless network node 420 from BS 410A (e.g., CU of BS 410A) to BS 410B (e.g., CU of BS 410B). In some examples, for each of the at least one UE, BS 410A may transmit a respective handover request message. In some examples, one handover request message may be applied to more than one UE of the at least one UE. BS 410B (e.g., CU of BS 410B) and wireless network node 420 (e.g., DU #2) may perform a UE context setup procedure for each of the at least one UE (e.g., UE 430). For example, the CU of BS 410B may transmit a UE context setup request message to DU #2 to create the UE context for UE 430 and set up one or more bearers. DU #2 may respond to BS 410B (e.g., CU of BS 410B) with a UE context setup response message. In some examples, for each of the at least one UE, BS 410B may transmit a respective UE context setup request message and may receive a respective UE context setup response message. In some examples, one UE context setup request message or one UE context setup response message may correspond to more than one UE of the at least one UE. BS 410B (e.g., CU of BS 410B) may perform admission control and transmit handover request acknowledgement message to BS 410A (e.g., CU of BS 410A). In some examples, for each of the at least one UE, BS 410B may transmit a respective handover request acknowledgement message, which includes a respective new RRC configuration for a corresponding UE. In some examples, one handover request acknowledgement message may include a plurality of new RRC configurations, each for a corresponding UE of a plurality of UEs of the at least one UE. BS 410A (e.g., CU of BS 410A) may transmit the new RRC configurations (e.g., in RRC reconfiguration messages) to corresponding UEs (e.g., UE 430). For example, the handover request acknowledgement message may include a new RRC configuration for UE 430. BS 410A (e.g., CU of BS 410A) may transmit the new RRC configuration for UE 430 to UE 430 in an RRC reconfiguration message.

In some embodiments, wireless network node 420 may be a mobile wireless network node such as a mobile IAB node. In some examples, in the case of mobile wireless network node migration, wireless network node 420 may not have descendant IAB nodes and may only serve UEs (e.g., inside or outside UEs). In some embodiments, BS 410A (e.g., CU of BS 410A) may only trigger the HO of the inside UEs (e.g., UEs located inside the vehicle on which wireless network node 420 is mounted) from BS 410A to BS 410B accompanied with the wireless network node 420, and may not trigger the HO of the outside UEs (e.g., UEs located outside the vehicle on which wireless network node 420 is mounted) from BS 410A to BS 410B accompanied with the wireless network node 420. For example, the handover request message(s) in operation 421 may only indicate to hand over the inside UEs.

In operation 423, UE 430 may be handed over from BS 410A (source BS) to BS 410B (target BS). For example, in response to receiving the RRC reconfiguration message, UE 430 may perform a random access procedure with DU #2 of wireless network node 420 and hand over (or migrate) to BS 410B (e.g., CU of BS 410B). UE 430 may transmit an RRC reconfiguration complete message to BS 410B (e.g., CU of BS 410B) after it switches to the new cell. In response to the RRC reconfiguration complete message, BS 410B (e.g., CU of BS 410B) may transmit a UE context release message for UE 430 to BS 410A (e.g., CU of BS 410A).

In operation 425, BS 410A may remove an F1 interface between wireless network node 420 (e.g., DU #1) and BS 410A (e.g., CU of BS 410A). In some examples, as stated above, the at least one UE may be the inside UEs. The outside UEs may reestablish connection to another wireless network node (e.g., an IAB node) or BS (e.g., IAB donor) in response to the F1 interface removal.

In some examples, BS 410A (e.g., CU of BS 410A) may determine whether all of the at least one UE to be handed over to BS 410B have migrated from BS 410A to BS 410B, or whether all of the at least one UE have detached from BS 410A. For example, BS 410A may determine whether all of the at least one UE have migrated to BS 410B based on whether BS 410A has received a UE context release message for each of the at least one UE. BS 410A may remove the F1 interface between DU #1 and the CU of BS 410A in response to determining that all of the at least one UE have migrated from BS 410A to BS 410B or in response to determining that all of the at least one UE have detached from BS 410A.

In some examples, BS 410A may start a timer for F1 interface removal in response to transmitting the HO request message for handing over the at least one UE or in response to transmitting the RRC reconfiguration message to the at least one UE. In some examples, in the case that a plurality of HO request messages or a plurality of RRC reconfiguration messages are transmitted, the timer may be started in response to transmitting the first one, the last one or any one of the plurality of HO request messages or the plurality of RRC reconfiguration messages.

BS 410A may remove the F1 interface between wireless network node 420 (e.g., DU #1) and BS 410A (e.g., CU of BS 410A) in response to the expiry of the timer for F1 interface removal. BS 410A may stop the timer in response to all of the at least one UE having migrated from BS 410A to BS 410B. The value of the timer can be set as the same value as the handover timer (e.g., timer T304 as specified in 3GPP specifications).

In operation 427, BS 410A (e.g., CU of BS 410A) may inform BS 410B (e.g., CU of BS 410B) of the removal of the F1 interface between wireless network node 420 (e.g., DU #1) and BS 410A (e.g., CU of BS 410A). In response to the indication, BS 410B (e.g., CU of BS 410B) may release certain configurations. For example, BS 410B (e.g., CU of BS 410B) may release the backhaul related configuration in the target path used for F1 transport from/to DU #1 of wireless network node 420 to/from BS 410A (e.g., CU of BS 410A). The backhaul related configuration may include, for example, a BAP routing ID(s) or a BH RLC CH(s) used for the F1 transport from/to DU #1 of wireless network node 420 to/from BS 410A (e.g., CU of BS 410A). For example, BS 410B (e.g., CU of BS 410B) may also release an IP address(es) for DU #1 allocated by BS 410B (e.g., CU of BS 410B).

It should be appreciated by persons skilled in the art that the sequence of the operations in exemplary procedure 400 may be changed and some of the operations in exemplary procedure 400 may be eliminated or modified, without departing from the spirit and scope of the disclosure.

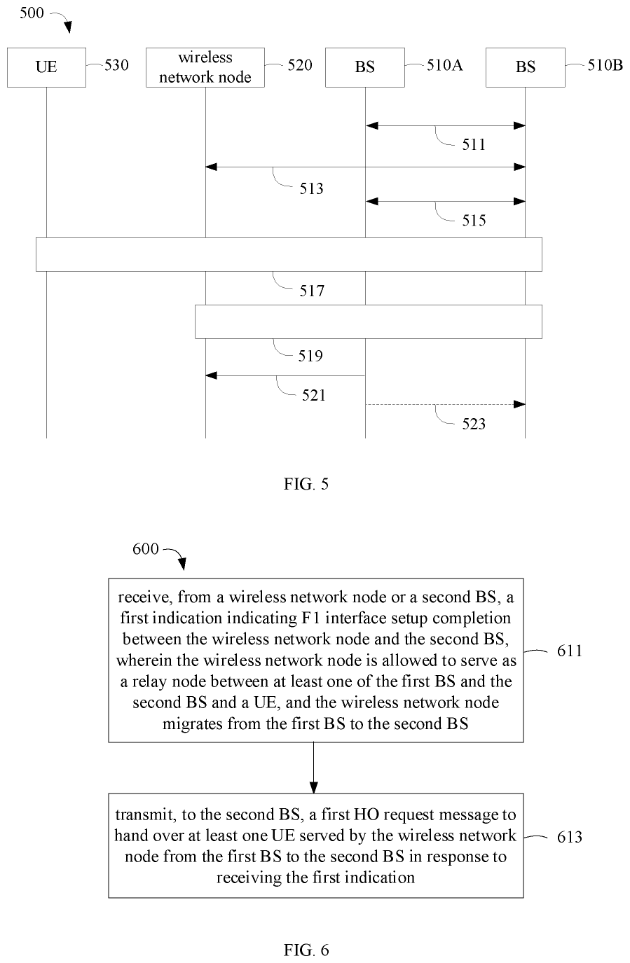

FIG. 5 illustrates a flow chart of exemplary procedure 500 for wireless communications in accordance with some embodiments of the present disclosure. Details described in all of the foregoing embodiments of the present disclosure are applicable for the embodiments shown in FIG. 5.

Referring to FIG. 5, wireless network node 520 may be directly or indirectly connected to BS 510A. For example, wireless network node 520 may be connected to a parent node (not shown in FIG. 5) which may be directly or indirectly connected to BS 510A. Wireless network node 520 may serve as a relay node between BS 510A and one or more UEs (e.g., UE 530).

In some embodiments, wireless network node 520 may include an MT and a DU (denoted as DU #1′), BS 510A may include a CU and a DU, and BS 510B may include a CU and a DU. For example, wireless network node 420 may be an IAB node and BS 410A and BS 410B may be an IAB donor. Both the MT and DU #1′ of wireless network node 520 may be anchored at BS 510A (e.g., CU of BS 510A).

In operation 511, BS 510A and BS 510B may perform a handover (HO) preparation procedure for the MT of wireless network node 520. For example, BS 510A (e.g., CU of BS 510A) may transmit a handover request message to BS 510B (e.g., CU of BS 510B). BS 510B (e.g., CU of BS 510B) may perform admission control and transmit a handover request acknowledgement message to BS 510A (e.g., CU of BS 510A). The handover request acknowledgement message may include a new RRC configuration for the MT of wireless network node 520.

In operation 513, an F1 interface between wireless network node 520 and BS 510B may be set up via the source path. The source path refers to the path between wireless network node 520 and BS 510A (e.g., DU of BS 510A). For example, another DU (denoted as DU #2′) may be introduced for establishing the F1 interface with BS 510B (e.g., CU of BS 510B). That is, DU #1′ of wireless network node 520 is associated with the source BS (BS 510A) and DU #2′ of wireless network node 520 is associated with the target BS (BS 510B). In response to the completion of the F1 interface setup between DU #2′ and the CU of BS 510B, the cells of DU #2′ may be activated and ready to serve UEs.

Compared to setting the F1 interface between a wireless network node and the target BS as shown in FIG. 4, the cells of DU #2′ of wireless network node 520 can be activated in advance and thus accelerate the handover of the UEs served by wireless network node 520 and the whole migration procedure.

In some embodiments, in response to the F1 interface setup completion between wireless network node 520 and BS 510B, wireless network node 520 or BS 510B (e.g., CU of BS 510B) may transmit an indication to BS 510A (e.g., CU of BS 510A) to inform of this F1 interface setup completion.

In response to the indication, BS 510A (e.g., CU of BS 510A) and BS 510B (e.g., CU of BS 510B) may perform an HO preparation procedure for the serving UEs (e.g., UE 530) of wireless network node 520 in operation 515. For example, BS 510A (e.g., CU of BS 510A) may transmit, to BS 510B (e.g., CU of BS 510B), a handover request message to hand over at least one UE (e.g., UE 530) served by wireless network node 520 from BS 510A (e.g., CU of BS 510A) to BS 510B (e.g., CU of BS 510B). In some examples, for each of the at least one UE, BS 510B may transmit a respective handover request message. In some examples, one handover request message may be applied to more than one UE of the at least one UE. BS 510B (e.g., CU of BS 510B) and wireless network node 520 (e.g., DU #2′) may perform a UE context setup procedure for each of the at least one UE (e.g., UE 430). For example, the CU of BS 510B may transmit a UE context setup request message to DU #2′ to create the UE context for UE 530 and set up one or more bearers. DU #2′ may respond to BS 510B (e.g., CU of BS 510B) with a UE context setup response message. In some examples, for each of the at least one UE, BS 510B may transmit a respective UE context setup request message and may receive a respective UE context setup response message. In some examples, one UE context setup request message or one UE context setup response message may correspond to more than one UE of the at least one UE. BS 510B (e.g., CU of BS 510B) may perform admission control and transmit a handover request acknowledgement message to BS 510A (e.g., CU of BS 510A). In some examples, for each of the at least one UE, BS 510B may transmit a respective handover request acknowledgement message, which includes a respective new RRC configuration for a corresponding UE. In some examples, one handover request acknowledgement message may include a plurality of new RRC configurations, each for a corresponding UE of a plurality of UEs of the at least one UE. BS 510A (e.g., CU of BS 510A) may transmit the new RRC configurations (e.g., in RRC reconfiguration messages) to corresponding UEs (e.g., UE 430). For example, the handover request acknowledgement message may include a new RRC configuration for UE 530.

In some embodiments, wireless network node 520 may be a mobile wireless network node such as a mobile IAB node. In some embodiments, BS 510A (e.g., CU of BS 510A) may only trigger the HO of the inside UEs (e.g., UEs located inside the vehicle on which wireless network node 520 is mounted) from BS 510A to BS 510B accompanied with the wireless network node 520, and may not trigger the HO of the outside UEs (e.g., UEs located outside the vehicle on which wireless network node 520 is mounted) from BS 510A to BS 510B accompanied with the wireless network node 520. For example, the HO preparation procedure for the UEs as described below and the handover procedure for the UEs as described below may be only directed to inside UEs. For example, the handover request message(s) in operation 515 may only indicate to hand over the inside UEs.

The HO of the MT of wireless network node 520 and the HO of the UEs served by wireless network node 520 can be performed in parallel. For example, the HO of the MT of wireless network node 520 may occur before the HO for any UE. For example, the HO of all UEs may before the HO of the MT of wireless network node 520. For example, the HO of some UEs may before the HO of the MT of wireless network node 520 and the HO of some other UEs may after the HO of the MT of wireless network node 520.

For example, in operation 517, UE 530 may be handed over from BS 510A (source BS) to BS 510B (target BS). For example, BS 510A (e.g., CU of BS 510A) may transmit, to UE 530, an RRC reconfiguration message indicating the new RRC configuration. In response to receiving the RRC reconfiguration message, UE 530 may perform a random access procedure with DU #2′ of wireless network node 520 and hand over (or migrate) to BS 510B (e.g., CU of BS 510B). UE 530 may transmit an RRC reconfiguration complete message to BS 510B (e.g., CU of BS 510B) after it switches to the new cell. In response to the RRC reconfiguration complete message, BS 510B (e.g., CU of BS 510B) may transmit a UE context release message for UE 530 to BS 510A (e.g., CU of BS 510A).

One or more other UEs (not shown in FIG. 5) may be handed over from BS 510A (source BS) to BS 510B (target BS) using a similar procedure. In some embodiments, all UEs may be handed over from BS 510A to BS 510B or detached from BS 510A (e.g., the HO may fail) before the HO of the MT of wireless network node 520.

It should be noted that although operation 511 is shown before operation 513 in FIG. 5, operation 511 may occur after operations 513 and 515, after operation 513 and before 515, or after operation 517 in some other embodiments of the present disclosure.

In operation 519, the MT of wireless network node 520 may be handed over from BS 510A (source BS) to BS 510B (target BS). For example, BS 510A (e.g., CU of BS 510A) may transmit, to wireless network node 520, an RRC reconfiguration message indicating the new RRC configuration. In response to receiving the RRC reconfiguration message, the MT of wireless network node 520 may perform a random access procedure with BS 510B (e.g., DU of BS 510B) and hand over (or migrate) to BS 510B (e.g., CU of BS 510B).

In response to the completion of the HO of the MT of wireless network node 520, the F1 interface (e.g., F1-C and F1-U connectivity) between wireless network node 520 (e.g., DU #2′) and BS 510B (e.g., CU of BS 510B) may be switched from the source path to the target path. The target path refers to the path between wireless network node 520 and BS 510B (e.g., DU of BS 510B). The RRC connection(s) of the at least one UE served by wireless network node 520 may be switched to the target path. For example, the RRC connection of the serving UE that has connected to BS 510B via operation 517 (e.g., UE 530) may be switched to the target path. For example, the RRC connection of a UE served by wireless network node 520 that has not connected to BS 510B may be switched to the target path.

In some embodiments of the present disclosure, there may be at least one remaining UE served by wireless network node 520 that needs to be handed over from BS 510A (source BS) to BS 510B (target BS) after the completion of the HO of the MT of wireless network node 520. In this case, the F1 interface (e.g., F1-C and F1-U connectivity) between wireless network node 520 (e.g., DU #1′) and BS 510A (e.g., CU of BS 510A) may be switched to the target path in response to the completion of the HO of the MT of wireless network node 520. The RRC connection of such UE(s) may also be switched to the target path.

The at least one remaining UE may be handed over to BS 510B after the HO of the MT of wireless network node 520. For example, the at least one remaining UE may perform a random access procedure with DU #2′ of wireless network node 520 and hand over (or migrate) to BS 510B (e.g., CU of BS 510B) based on the received RRC reconfiguration message. The at least one remaining UE may transmit an RRC reconfiguration complete message to BS 510B (e.g., CU of BS 510B) after it switches to the new cell. In response to the RRC reconfiguration complete message, BS 510B (e.g., CU of BS 510B) may transmit a UE context release message for UE 530 to BS 510A (e.g., CU of BS 510A).

In operation 521, BS 510A may remove an F1 interface between wireless network node 520 (e.g., DU #1′) and BS 510A (e.g., CU of BS 510A). In some examples, BS 510A (e.g., CU of BS 510A) may determine whether all of the UEs to be handed over to BS 510B have migrated from BS 510A to BS 510B, or whether all of the UEs have detached from BS 510A. For example, BS 510A may determine whether all of the at least one UE have migrated to BS 510B based on whether BS 510A has received a UE context release message for each of the at least one UE. BS 510A may remove the F1 interface between DU #1′ and the CU of BS 510A in response to determining that all of the at least one UE have migrated from BS 510A to BS 510B or in response to determining that all of the at least one UE have detached from BS 510A.

In some examples, BS 510A may start a timer for F1 interface removal in response to transmitting the HO request message for handing over the at least one UE or in response to transmitting the RRC reconfiguration message to the at least one UE. In some examples, in the case that a plurality of HO request messages or a plurality of RRC reconfiguration messages are transmitted, the timer may be started in response to transmitting the first one, the last one or any one of the plurality of HO request messages or the plurality of RRC reconfiguration messages.

BS 510A may remove the F1 interface between wireless network node 520 (e.g., DU #1′) and BS 510A (e.g., CU of BS 510A) in response to the expiry of the timer for F1 interface removal. BS 510A may stop the timer in response to all of the at least one UE having migrated from BS 510A to BS 510B. The value of the timer can be set as the same value as the handover timer (e.g., timer T305 as specified in 3GPP specifications).

In some examples, as stated above, the at least one UE to be handed over may be the inside UEs. The outside UEs may reestablish connection to another wireless network node (e.g., an IAB node) or BS (e.g., IAB donor) in response to the F1 interface removal.

It should be noted that although operation 521 is shown after operation 519 in FIG. 5, operation 521 may occur before operation 519 in some other embodiments of the present disclosure, for example, when all of the at least one UE are handed over before the HO of the MT of wireless network node 520.

As described above, under a certain case, the F1 interface between wireless network node 520 (e.g., DU #1′) and BS 510A (e.g., CU of BS 510A) may be switched to the target path. In this case, BS 510A (e.g., CU of BS 510A) may inform BS 510B (e.g., CU of BS 510B) of the removal of the F1 interface between wireless network node 520 (e.g., DU #1′) and BS 510A (e.g., CU of BS 510A) in operation 523 (denoted in a dotted line as an option). In response to the indication, BS 510B (e.g., CU of BS 510B) may release certain configurations. For example, BS 510B (e.g., CU of BS 510B) may release the backhaul related configuration in the target path used for F1 transport from/to DU #1′ of wireless network node 520 to/from BS 510A (e.g., CU of BS 510A). The backhaul related configuration may include, for example, a BAP routing ID(s) or a BH RLC CH(s) used for the F1 transport from/to DU #1′ of wireless network node 520 to/from BS 510A (e.g., CU of BS 510A). For example, BS 510B (e.g., CU of BS 510B) may also release an IP address(es) for DU #1′ allocated by BS 510B (e.g., CU of BS 510B).

It should be appreciated by persons skilled in the art that the sequence of the operations in exemplary procedure 500 may be changed and some of the operations in exemplary procedure 500 may be eliminated or modified, without departing from the spirit and scope of the disclosure.

As illustrated above, during the full migration of a wireless network node, the wireless network node may have F1 connectivity to both the source BS and the target BS. For example, one (e.g., DU #1 or DU #1′) of the two DUs of the wireless network node may be associated with the source BS (CU of the source BS) and another DU (e.g., DU #2 or DU #2′) may be associated with the target BS (CU of the target BS). When the MT of the wireless network node receives DL traffic (e.g., BAP data protocol data unit (PDU)) from its parent node, solutions for differentiating whether the DL traffic is from the source BS or the target BS or solutions for delivering the DL traffic to the right DU of the wireless network node are desired.

In some embodiments of the present disclosure, the BAP header of a DL packet may include an indicator to differentiate whether the DL packet is from the source BS (e.g., CU of source BS) or the target BS (e.g., CU of target BS). In some other embodiments of the present disclosure, the BAP header of a DL packet may include an indicator to differentiate whether the DL packet is sent to the DU associated with the source BS or the DU associated with the target BS. In some embodiments, such indicator may be only provided in a DL packet from the target BS or a DL packet sent to the DU associated with the target BS.

In some embodiments of the present disclosure, a separate IP address(es) may be provided for the DU associated with the source BS and for the DU associated with the target BS. For example, the IP address(es) for the DU associated with the source BS may be different from the IP address(es) for the DU associated with the target BS. The wireless network node may thus determine the right DU to deliver to based on the destination IP address of a DL packet. For example, if the destination IP address of a DL packet belongs to the IP address(es) for the DU associated with the source BS, the wireless network node may determine the DL packet is from the source BS and deliver it to the DU associated with the source BS.

According to the above embodiments of the present disclosure, a wireless network node may perform a routing procedure according to the following pseudo-code:

```
Upon receiving a BAP Data PDU from a lower layer (i.e., ingress BH RLC
channel), the receiving part of the BAP entity shall:
  - if the DESTINATION field of this BAP Data PDU matches the BAP address,
    which is configured for this node by the IAB-donor providing this ingress BH
    RLC channel configuration [(i.e. the one of ingress topology)] :
    - For UL, remove the BAP header of this BAP Data PDU and deliver the
    BAP SDU to upper layers. For DL, remove the BAP header of this BAP
    Data PDU and deliver the BAP SDU to upper layers in the right collocated
    IAB-DU based on the explicit indicator in the BAP header or based on the
    destination IP address.
  - else:
    - For UL, deliver the BAP Data Packet to the transmitting part of the
    collocated BAP entity. For DL, deliver the BAP Data Packet to the
    transmitting part of the BAP entity in the right collocated IAB-DU based on
    the explicit indicator in the BAP header or based on the destination IP
    address.
```

FIG. 6 illustrates a flow chart of exemplary procedure 600 of wireless communications in accordance with some embodiments of the present disclosure. Details described in all of the foregoing embodiments of the present disclosure are applicable for the embodiments shown in FIG. 6.

Referring to FIG. 6, in operation 611, a BS (denoted as “first BS” for clarity) may receive, from a wireless network node or another BS (denoted as “second BS” for clarity), an indication (denoted as “first indication” for clarity) indicating F1 interface setup completion between the wireless network node (e.g., DU #2 or DU #2′ as described above) and the second BS (e.g., IAB-CU). The wireless network node may be allowed to serve as a relay node between at least one of the first BS and the second BS and a UE, and the wireless network node migrates from the first BS to the second BS. That is, the first BS and the second BS may be the source BS and the target BS for the migration (or handover) of the wireless network node.

In some embodiments, the first BS may function as BS 410A in FIG. 4 or BS 510A in FIG. 5, the second BS may function as BS 410B in FIG. 4 or BS 510B in FIG. 5, the wireless network node may function as wireless network node 420 in FIG. 4 or wireless network node 520 in FIG. 5.

In operation 613, the first BS may transmit, to the second BS, a HO request message (denoted as “first HO request message” for clarity) to hand over at least one UE served by the wireless network node from the first BS to the second BS in response to receiving the first indication.

In some embodiments, the wireless network node may be mounted on a vehicle and the at least one serving UE may be located inside the vehicle.

In some embodiments, the first BS may determine whether all of the at least one UE have migrated from the first BS to the second BS or whether all of the at least one UE have detached from the first BS. The first BS may remove an F1 interface between the wireless network node (e.g., DU #1 or DU #1′ as described above) and the first BS (e.g., IAB-CU) in response to determining that all of the at least one UE have migrated from the first BS to the second BS or in response to determining that all of the at least one UE have detached from the first BS.

In some embodiments, determining whether all of the at least one UE have migrated from the first BS to the second BS may include determining whether the first BS has received a UE context release message(s) for all of the at least one UE.

In some embodiments, the first BS may start a timer for F1 interface removal in response to transmitting the first HO request message. The first BS may remove an F1 interface between the wireless network node (e.g., DU #1 or DU #1′ as described above) and the first BS (e.g., IAB-CU) in response to an expiry of the timer for F1 interface removal.

In some embodiments, the first BS may receive, from the second BS, a HO request acknowledgement message in response to the first HO request message. The first BS may transmit an RRC reconfiguration message to the at least one UE in response to receiving the HO request acknowledgement message. The first BS may start a timer for F1 interface removal in response to transmitting the RRC reconfiguration message. The first BS may remove an F1 interface (e.g., DU #1 or DU #1′ as described above) between the wireless network node and the first BS (e.g., IAB-CU) in response to an expiry of the timer for F1 interface removal.

In some embodiments, the first BS may transmit, to the second BS, an indication (denoted as “second indication” for clarity) indicating the removal of the F1 interface between the wireless network node and the first BS (e.g., IAB-CU). For example, as shown in operation 427 of FIG. 4, BS 410A may inform BS 410B of the removal of the F1 interface between wireless network node 420 and BS 410A. For example, as shown in operation 523 of FIG. 5, BS 510A may inform BS 510B of the removal of the F1 interface between wireless network node 520 and BS 510A.

In some embodiments, the first BS may perform a HO procedure to hand over an MT of the wireless network node from the first BS to the second BS. The F1 interface setup completion between the wireless network node (e.g., DU #2′) and the second BS (e.g., IAB-CU) may precede the HO of the MT of the wireless network node. The first BS may perform at least one of the following: switch the F1 interface between the wireless network node and the second BS set up via a source path between the wireless network node and the first BS to a target path between the wireless network node and the second BS; or switch an RRC connection of the at least one UE to the target path. In some embodiments, in response to that one or more UEs of the at least one UE has not been handed over to the second BS when the HO of the MT of the wireless network node is completed, the first BS may switch an F1 interface between the wireless network node (e.g., DU #1′) and the first BS to the target path. An example is shown in FIG. 5.

It should be appreciated by persons skilled in the art that the sequence of the operations in exemplary procedure 600 may be changed and some of the operations in exemplary procedure 600 may be eliminated or modified, without departing from the spirit and scope of the disclosure.

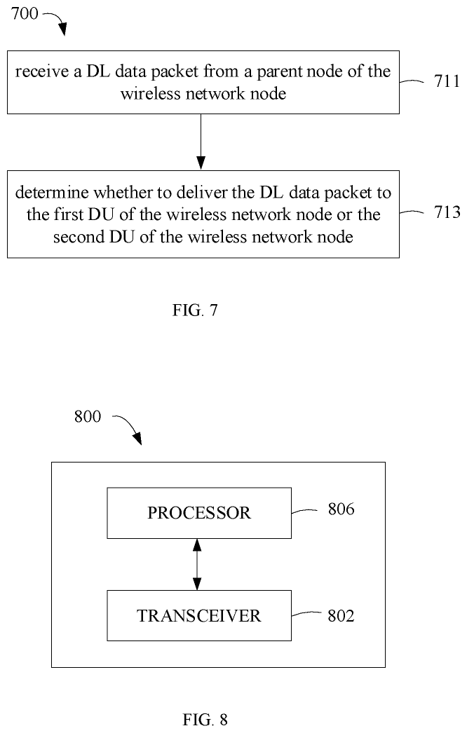

FIG. 7 illustrates a flow chart of exemplary procedure 700 for wireless communications in accordance with some embodiments of the present disclosure. Details described in all of the foregoing embodiments of the present disclosure are applicable for the embodiments shown in FIG. 7.

In FIG. 7, a wireless network node may migrate from a first BS to a second BS. The wireless network node may include a first DU (e.g., DU #1 or DU #1′) associated with the first BS and a second DU (e.g., DU #2 or DU #2′) associated with the second BS. In some embodiments, the first BS may function as BS 410A in FIG. 4 or BS 510A in FIG. 5, the second BS may function as BS 410B in FIG. 4 or BS 510B in FIG. 5, the wireless network node may function as wireless network node 420 in FIG. 4 or wireless network node 520 in FIG. 5.

In operation 711, a wireless network node may receive a DL data packet from a parent node of the wireless network node. In operation 713, the wireless network node may determine whether to deliver the DL data packet to the first DU of the wireless network node or the second DU of the wireless network node.

In some embodiments, a BAP header of the data packet may include an indicator indicating whether the DL data packet is from the first BS or the second BS or indicating whether the DL data packet is to the first DU or the second DU. The wireless network node may determine whether to deliver the DL data packet to the first DU or the second DU based on the indicator.

In some embodiments, determining whether to deliver the DL data packet to the first DU or the second DU may include: determining to deliver the DL data packet to the second DU in response to a BAP header of the data packet indicating that the DL data packet is from the second BS or to the second DU; or determining to deliver the DL data packet to the first DU in response to the BAP header of the data packet does not indicate which BS the DL data packet is from or which DU the DL data packet is destined to.

In some embodiments, an IP address for the first DU may be different from that for the second DU. The wireless network node may determine whether to deliver the DL data packet to the first DU or the second DU based on the IP addresses for the first and second DUs and a destination IP address of the DL data packet.

In some embodiments, the wireless network node may set up an F1 interface between the second DU and the second BS. The wireless network node may transmit an indication indicating a completion of the setup of the F1 interface. Examples are shown in FIGS. 4 and 5.

It should be appreciated by persons skilled in the art that the sequence of the operations in exemplary procedure 700 may be changed and some of the operations in exemplary procedure 700 may be eliminated or modified, without departing from the spirit and scope of the disclosure.

FIG. 8 illustrates a block diagram of exemplary apparatus 800 according to some embodiments of the present disclosure.

As shown in FIG. 8, the apparatus 800 may include at least one processor 806 and at least one transceiver 802 coupled to the processor 806. The apparatus 800 may be a UE, a wireless network node (e.g., an IAB node), or a BS (e.g., an IAB donor, IAB donor-CU, or IAB donor-DU).

Although in this figure, elements such as the at least one transceiver 802 and processor 806 are described in the singular, the plural is contemplated unless a limitation to the singular is explicitly stated. In some embodiments of the present application, the transceiver 802 may be divided into two devices, such as a receiving circuitry and a transmitting circuitry. In some embodiments of the present application, the apparatus 800 may further include an input device, a memory, and/or other components.

In some embodiments of the present application, the apparatus 800 may be a UE. The transceiver 802 and the processor 806 may interact with each other so as to perform the operations with respect to the UE described in FIGS. 1-7. In some embodiments of the present application, the apparatus 800 may be a wireless network node. The transceiver 802 and the processor 806 may interact with each other so as to perform the operations with respect to the wireless network node or the IAB node (mobile or stationary) described in FIGS. 1-7. In some embodiments of the present application, the apparatus 800 may be a BS. The transceiver 802 and the processor 806 may interact with each other so as to perform the operations with respect to the BS, the IAB donor, IAB donor-CU, or IAB donor-DU described in FIGS. 1-7.

In some embodiments of the present application, the apparatus 800 may further include at least one non-transitory computer-readable medium.

For example, in some embodiments of the present disclosure, the non-transitory computer-readable medium may have stored thereon computer-executable instructions to cause the processor 806 to implement the method with respect to the UE as described above. For example, the computer-executable instructions, when executed, cause the processor 806 interacting with transceiver 802 to perform the operations with respect to the UE described in FIGS. 1-7.

For example, in some embodiments of the present disclosure, the non-transitory computer-readable medium may have stored thereon computer-executable instructions to cause the processor 806 to implement the method with respect to the wireless network node or the IAB node (mobile or stationary) as described above. For example, the computer-executable instructions, when executed, cause the processor 806 interacting with transceiver 802 to perform the operations with respect to the wireless network node or the IAB node (mobile or stationary) described in FIGS. 1-7.

In some embodiments of the present disclosure, the non-transitory computer-readable medium may have stored thereon computer-executable instructions to cause the processor 806 to implement the method with respect to the BS, the IAB donor, IAB donor-CU, or IAB donor-DU as described above. For example, the computer-executable instructions, when executed, cause the processor 806 interacting with transceiver 802 to perform the operations with respect to the BS, the IAB donor, IAB donor-CU, or IAB donor-DU described in FIGS. 1-7.

Those having ordinary skill in the art would understand that the operations or steps of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the operations or steps of a method may reside as one or any combination or set of codes and/or instructions on a non-transitory computer-readable medium, which may be incorporated into a computer program product.

While this disclosure has been described with specific embodiments thereof, it is evident that many alternatives, modifications, and variations may be apparent to those skilled in the art. For example, various components of the embodiments may be interchanged, added, or substituted in other embodiments. Also, all of the elements of each figure are not necessary for the operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including.” Expressions such as “A and/or B” or “at least one of A and B” may include any and all combinations of words enumerated along with the expression. For instance, the expression “A and/or B” or “at least one of A and B” may include A, B, or both A and B. The wording “the first,” “the second” or the like is only used to clearly illustrate the embodiments of the present application, but is not used to limit the substance of the present application.

1. A first base station, comprising:
at least one memory; and
at least one processor coupled with the at least one memory and configured to cause the first base station to:
receive, from a wireless network node or a second base station, a first indication indicating F1 interface setup completion between the wireless network node and the second base station, wherein the wireless network node is allowed to serve as a relay node between at least one of the first base station and the second base station and a user equipment (UE), and the wireless network node migrates from the first base station to the second base station; and
transmit, to the second base station, a first handover (HO) request message to hand over at least one UE served by the wireless network node from the first base station to the second base station in response to receiving the first indication.

2. The first base station of claim 1, wherein the wireless network node is mounted on a vehicle and the at least one serving UE is located inside the vehicle.

3. The first base station of claim 1, wherein the at least one processor is configured to cause the first base station to:
determine whether all of the at least one UE have migrated from the first base station to the second base station or whether all of the at least one UE have detached from the first base station; and
remove an F1 interface between the wireless network node and the first base station in response to determining that all of the at least one UE have migrated from the first base station to the second base station or in response to determining that all of the at least one UE have detached from the first base station.

4. The first base station of claim 3, wherein determining whether all of the at least one UE have migrated from the first base station to the second base station comprises determining whether the first base station has received a UE context release message(s) for all of the at least one UE.

5. The first base station of claim 1, wherein the at least one processer is configured to cause the first base station to:
start a timer for F1 interface removal in response to transmitting the first HO request message; and
remove an F1 interface between the wireless network node and the first base station in response to an expiry of the timer for F1 interface removal.

6. The first base station of claim 1, wherein the at least one processor is configured to cause the first base station to:
receive, from the second base station, a HO request acknowledgement message in response to the first HO request message; and
transmit a radio resource control (RRC) reconfiguration message to the at least one UE in response to receiving the HO request acknowledgement message;
start a timer for F1 interface removal in response to transmitting the RRC reconfiguration message; and
remove an F1 interface between the wireless network node and the first base station in response to an expiry of the timer for F1 interface removal.

7. The first base station of claim 6, wherein the at least one processor is configured to cause the first base station to transmit, to the second base station, a second indication indicating the removal of the F1 interface between the wireless network node and the first base station.

8. The first base station of claim 6, wherein the at least one processor is configured to cause the first base station to perform a HO procedure to hand over a mobile termination (MT) of the wireless network node from the first base station to the second base station;
wherein the F1 interface setup completion between the wireless network node and the second base station precedes the HO of the MT of the wireless network node; and
wherein the at least one processor is configured to cause the first base station to perform at least one of the following:
switch the F1 interface between the wireless network node and the second base station set up via a source path between the wireless network node and the first base station to a target path between the wireless network node and the second base station; or
switch a radio resource control (RRC) connection of the at least one UE to the target path.

9. The first base station of claim 8, wherein the at least one processor is configured to cause the first base station to: in response to that one or more UEs of the at least one UE has not been handed over to the second base station when the HO of the MT of the wireless network node is completed, switch an F1 interface between the wireless network node and the first base station to the target path.

10. A wireless network node, comprising:
at least one memory; and
at least one processor coupled with the at least one memory and configured to cause the wireless network node to:
receive a downlink (DL) data packet from a parent node of the wireless network node; and
determine whether to deliver the DL data packet to a first distributed unit (DU) of the wireless network node or a second DU of the wireless network node,
wherein the first DU is associated with a first base station, the second DU is associated with a second base station, and the wireless network node migrates from the first base station to the second base station.

11. The wireless network node of claim 10, wherein a backhaul adaptation protocol (BAP) header of the data packet comprises an indicator indicating whether the DL data packet is from the first base station or the second base station or indicating whether the DL data packet is to the first DU or the second DU; and
wherein the at least one processor is configured to cause the wireless network node to determine whether to deliver the DL data packet to the first DU or the second DU based on the indicator.

12. The wireless network node of claim 10, wherein determining whether to deliver the DL data packet to the first DU or the second DU comprises:
determining to deliver the DL data packet to the second DU in response to a backhaul adaptation protocol (BAP) header of the data packet indicating that the DL data packet is from the second BS or to the second DU; or
determining to deliver the DL data packet to the first DU in response to the BAP header of the data packet does not indicate which BS the DL data packet is from or which DU the DL data packet is destined to.

13. The wireless network node of claim 10, wherein an internet protocol (IP) address for the first DU is different from that for the second DU, and wherein the at least one processor is configured to cause the wireless network node to determine whether to deliver the DL data packet to the first DU or the second DU based on the IP addresses for the first and second DUs and a destination IP address of the DL data packet.

14. The wireless network node of claim 10, wherein the at least one processor is configured to cause the wireless network node to set up an F1 interface between the second DU and the second base station and transmit an indication indicating a completion of a setup of the F1 interface.

15. A method performed by first base station, the method comprising:
receiving, from a wireless network node or a second base station, a first indication indicating F1 interface setup completion between the wireless network node and the second base station, wherein the wireless network node is allowed to serve as a relay node between at least one of the first base station and the second base station and a user equipment (UE), and the wireless network node migrates from the first base station to the second base station; and
transmitting, to the second base station, a first handover (HO) request message to hand over at least one UE served by the wireless network node from the first base station to the second base station in response to receiving the first indication.

16. The method of claim 15, wherein the wireless network node is mounted on a vehicle and the at least one serving UE is located inside the vehicle.

17. The method of claim 15, further comprising:
determining whether all of the at least one UE have migrated from the first base station to the second base station or whether all of the at least one UE have detached from the first base station; and
removing an F1 interface between the wireless network node and the first base station in response to determining that all of the at least one UE have migrated from the first base station to the second base station or in response to determining that all of the at least one UE have detached from the first base station.

18. The method of claim 17, wherein determining whether all of the at least one UE have migrated from the first base station to the second base station comprises determining whether the first base station has received a UE context release message(s) for all of the at least one UE.

19. The method of claim 15, further comprising:
starting a timer for F1 interface removal in response to transmitting the first HO request message; and
removing an F1 interface between the wireless network node and the first base station in response to an expiry of the timer for F1 interface removal.

20. A method performed by a wireless network node, the method comprising:
receiving a downlink (DL) data packet from a parent node of the wireless network node; and
determining whether to deliver the DL data packet to a first distributed unit (DU) of the wireless network node or a second DU of the wireless network node,
wherein the first DU is associated with a first base station, the second DU is associated with a second base station, and the wireless network node migrates from the first base station to the second base station.
